(19) United States
(12) Patent Application Publication
(10) Pub. No.: US 2026/0017135 A1
(43) Pub. Date: Jan. 15, 2026

(54) COMPUTER PROGRAM, INFORMATION PROCESSING APPARATUS, AND INFORMATION PROCESSING METHOD

(71) Applicant: Tokyo Electron Limited, Tokyo (JP)

(72) Inventors: Ruiki KOBAYASHI, Koshi City (JP); Dai KOBAYASHI, Sapporo City (JP); Takahiro NAKAMURA, Sapporo City (JP)

(73) Assignee: Tokyo Electron Limited, Tokyo (JP)

(21) Appl. No.: 19/337,939

(22) Filed: Sep. 24, 2025

Related U.S. Application Data
(63) Continuation of application No. PCT/JP2024/012199, filed on Mar. 27, 2024.

(30) Foreign Application Priority Data
Apr. 6, 2023 (JP) 2023-062215

(51) Int. Cl. G06F 11/07; G06F 11/34

(52) U.S. Cl. CPC G06F 11/079; G06F 11/3447

(57) ABSTRACT

A non-transitory computer-readable medium storing a computer program which, when executed by a computer, causes the computer to execute a process including acquiring a first feature value from a first feature value extraction model, which outputs the first feature value when data of a first modality about substrate processing is received; acquiring a second feature value from a second feature value extraction model which outputs the second feature value when data of a second modality different from the first modality is received; calculating a similarly between the first feature value and second feature value; and training at least one of the first feature value extraction model and the second feature value extraction model based on the similarity.

### CROSS-REFERENCE TO RELATED APPLICATIONS

This application is a bypass continuation application of international application No. PCT/JP2024/012199 having an international filing date of Mar. 27, 2024 and designating the United States, the international application being based upon and claiming the benefit of priority from Japanese Patent Application No. 2023-062215, filed on Apr. 6, 2023, the entire contents of each are incorporated herein by reference.

### TECHNICAL FIELD

The present disclosure relates to a non-transitory computer-readable medium, an information processing apparatus, and an information processing method.

### BACKGROUND

In recent years, artificial intelligence using a neural network or the like has been used in various fields such as image recognition, voice recognition, and language processing. Further, in addition to artificial intelligence that handles only data in a specific modality (for example, image data), the development of artificial intelligence that handles a plurality of modalities with respect to one target, such as image data, voice data, and text data, has also been advanced (for example, see PTL 1).

### CITATION LIST

### Patent Documents

PTL 1: JP2019-535063A

### SUMMARY

The present disclosure provides a computer program, an information processing apparatus, and an information processing method for performing an analysis in consideration of interrelationships between a plurality of modalities.

In accordance with the present disclosure, anon-transitory computer-readable medium storing a computer program which, when executed by a computer, causes the computer to execute processing comprising: acquiring a first feature value from a first feature value extraction model, which outputs the first feature value when data of a first modality about substrate processing is received; acquiring a second feature value from a second feature value extraction model, which outputs the second feature value when data of a second modality different from the first modality is received; calculating a similarly between the first feature value and second feature value; and training at least one of the first feature value extraction model and the second feature value extraction model based on the similarity.

According to the present disclosure, it is possible to perform an analysis in consideration of interrelationships between a plurality of modalities.

### BRIEF DESCRIPTION OF DRAWINGS

FIG. 1 is an illustrative diagram illustrating a configuration of an information processing system according to an embodiment.

FIG. 2 is a block diagram illustrating an internal configuration of an information processing apparatus.

FIG. 3 is a flowchart illustrating a procedure of learning an interrelationship between a first modality and a second modality.

FIG. 4 is a flowchart illustrating a procedure of executing abnormality detection processing.

FIG. 5 is an illustrative diagram illustrating a method of setting similarity between a first feature value and a second feature value.

FIG. 6 is a flowchart illustrating a learning procedure in Embodiment 2.

FIG. 7 is an illustrative diagram illustrating an outline of factor analysis processing.

FIG. 8 is a flowchart illustrating a procedure of processing executed by an information processing apparatus according Embodiment 3.

FIG. 9 is an illustrative diagram illustrating an outline of data expansion processing.

FIG. 10 is a flowchart illustrating a procedure of processing executed by an information processing apparatus according to Embodiment 4.

FIG. 11 is an illustrative diagram illustrating an outline of prediction processing.

FIG. 12 is a flowchart illustrating a procedure of processing executed by an information processing apparatus according to Embodiment 5.

FIG. 13 is an illustrative diagram illustrating an outline of noise removal processing.

FIG. 14 is a flowchart illustrating a procedure of processing executed by an information processing apparatus according to Embodiment 6.

### DETAILED DESCRIPTION

Hereinafter, embodiments will be described with reference to the drawings. In the description, the same elements or elements having the same function are denoted by the same reference numerals, and overlapping descriptions thereof will be omitted.

### Embodiment 1

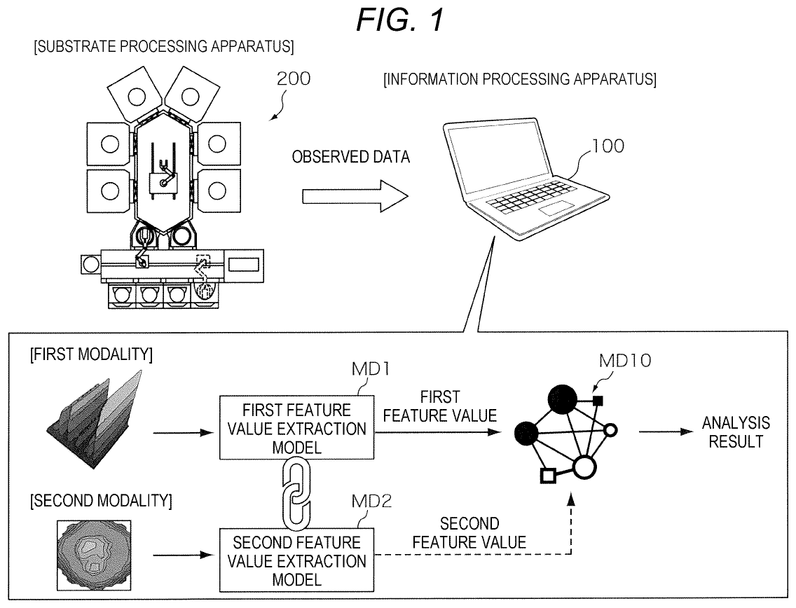

FIG. 1 is an illustrative diagram illustrating a configuration an information processing system according to an embodiment. The information processing system according to the embodiment includes an information processing apparatus 100 and a substrate processing apparatus 200 communicably connected to each other.

The substrate processing apparatus 200 is, for example, a semiconductor manufacturing apparatus that includes at least one of an exposure apparatus, an etching apparatus, a film forming apparatus, an ion implantation apparatus, an ashing apparatus, a sputtering apparatus, and the like. Alternatively, the substrate processing apparatus 200 may be a display manufacturing apparatus that manufactures a flat display panel (FDP) such as a liquid crystal display panel or an organic electro-luminescence (EL) panel.

Various set values for a temperature of a substrate, a pressure or a gas flow rate in a chamber, a voltage applied from a radio-frequency power supply, and the like are set in the substrate processing apparatus 200 at the start of a process. The set value is given by, for example, a process recipe. The substrate processing apparatus 200 is provided with various sensors and devices that measure the temperature of the substrate, the pressure and gas flow rate in the chamber, voltages applied to an upper electrode and a lower electrode, a plasma emission intensity, and the like, and various measurement values are obtained during execution of the process. Further, the substrate processing apparatus 200 collects, not limited to the measurement values described above, data such as image data and process logs of substrates (wafers) before and after the process at any time. The substrate processing apparatus 200 outputs data of various modalities such as measurement values, image data, and process logs measured during the execution of the process to the information processing apparatus 100.

The information processing apparatus 100 acquires data of various modalities from the substrate processing apparatus 200. The information processing apparatus 100 performs various types of analysis processing based on the data acquired from the substrate processing apparatus 200.

In related art, there are analysis methods which use data of various modalities. For example, after a feature value is extracted from data of a specific modality, analysis processing for performing a task is performed using the feature value of the modality.

However, in the method in the related art in which a task is performed by using feature values of individual modalities, only analysis dependent on a specific modality can be performed, and even if there are a plurality of modalities, analysis in consideration of interrelationships between the plurality of modalities can not be performed. For example, when abnormality detection is performed using data of a modality representing performance (for example, image data of a substrate), an abnormality affecting performance can be detected. However, a factor thereof cannot be specified. When an abnormality is detected using a modality (for example, process log) that makes it easy to specify the factor, the factor of the abnormality can be specified. However, an abnormality affecting performance cannot be detected.

Therefore, embodiments of the present disclosure, such as that in FIG. 1, propose a method of performing analysis processing by learning interrelationships between a plurality of modalities and utilizing a feature appearing in one modality (first modality) in another modality (second modality). In Embodiment 1, as an example, a configuration will be described in which abnormality detection is performed using a first feature value extraction model MD1, a second feature value extraction model MD2, and an abnormality detection model MD10.

The first feature value extraction model MD1 is configured to output, when data of the first modality is received, a feature value of the data. The data of the first modality is, for example, measurement data about plasma emission intensity measured by an optical emission spectrometer (OES). As long as the data of the first modality is data about substrate processing, the data of the first modality is not limited to the measurement data about the plasma emission intensity. For example, the data of the first modality may be measurement data such as the temperature of the substrate, the pressure or the gas flow rate in the chamber, the voltage applied to the upper electrode or the lower electrode, or image data about an observation image obtained by a scanning electron microscope (SEM) or the like, or may be data about a process log or the like.

As the first feature value extraction model MD1, a learning model of machine learning that includes deep learning can be used. For example, a learning model based on a convolutional neural network (CNN), transformer, recurrent neural networks (RNN), long short term memory (LSTM), or multi-layer perceptrons (MLP) can be used. Alternatively, a learning model other than deep learning, such as an autoregressive model, a moving average model, or an autoregressive moving average model, may be used. The learning model used for the first feature value extraction model MD1 is appropriately set according to the data of the first modality that is received, content to be analyzed, and the like.

The first feature value extraction model MD1 includes, for example, an input layer, one or more intermediate layers, and an output layer, and is trained to output a feature value from the output layer in response to an input of data to the input layer. Alternatively, a value output from any one of the intermediate layers may be extracted as a feature value. The first feature value extraction model MD1 may include only the input layer and the output layer, without including the intermediate layer. Hereinafter, the data of the first modality will also be referred to as first modal data, and the feature value extracted by the first feature value extraction model MD1 will also be referred to as a first feature value.

The second feature value extraction model MD2 is configured to output, when data of the second modality is received, a feature value of the data. The data of the second modality is, for example, image data relating to a color image of a surface of the substrate imaged by a wafer optical inspection system (also referred to as a WIS). As long as the data of the second modality is data about substrate processing, the data of the second modality is not limited to the image data obtained by the wafer optical inspection system. For example, the data of the second modality may be measurement data such as the temperature of the substrate, the pressure or the gas flow rate in the chamber, the voltage applied to the upper electrode or the lower electrode, or image data about an observation image obtained by SEM or the like, or may be data about a process log or the like. In implementations, the second modality is a modality different from the first modality.

Similarly to the first feature value extraction model MD1, the second feature value extraction model MD2 uses any model such as a learning model of machine learning that includes deep learning or a learning model other than deep learning. The learning model used for the second feature value extraction model MD2 is appropriately set according to the data of the second modality that is received, content to be analyzed, and the like. Hereinafter, the data of the second modality will also be referred to as second modal data, and a second feature value extracted by the second feature value extraction model MD2 will also be referred to as a second feature value.

The abnormality detection model MD10 is a model configured to output information on presence or absence of an abnormality in substrate processing in response to an input of the first feature value or the second feature value. As the abnormality detection model MD10, a learning model of machine learning including deep learning can be used. For example, a learning model based on CNN, Transformer, RNN, LSTM, or MLP can be used. Alternatively, a learning model other than deep learning, such as an autoregressive model, a moving average model, or an autoregressive moving average model, may be used.

In the embodiment, at least one of the first feature value extraction model MD1 and the second feature value extraction model MD2 is trained according to similarity between the first feature value and the second feature value, thereby learning an interrelationship between modalities. For example, the information processing apparatus 100 extracts the first feature value from the first modal data using the first feature value extraction model MD1 that learns the interrelationship between the modalities, and inputs the extracted first feature value into the abnormality detection model MD10 to detect an abnormality. As a result, for example, when the first modal data is used as measurement data obtained by OES and the second modal data is used as image data obtained by WIS, the abnormality detection can be implemented taking into consideration spatial information (features obtained from the image data) by using only the measurement data obtained by OES.

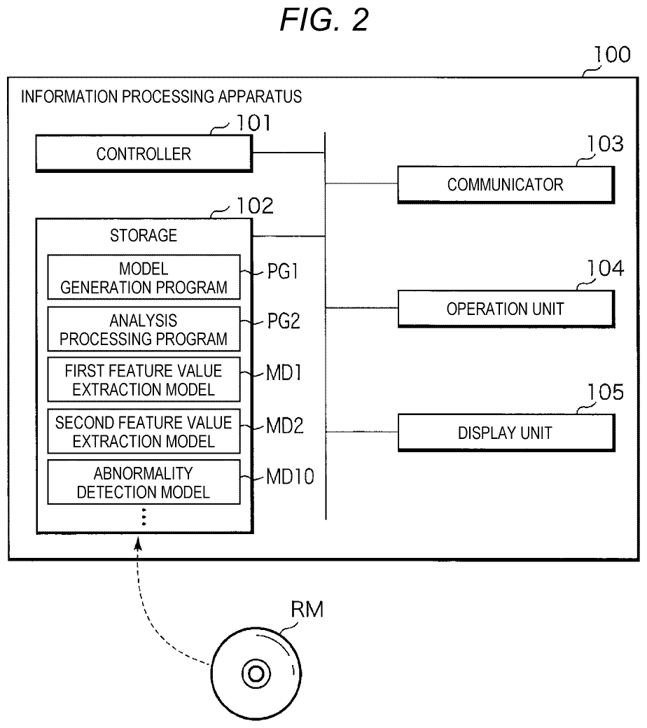

FIG. 2 is a block diagram illustrating an internal configuration of the information processing apparatus 100. The information processing apparatus 100 is, for example, a dedicated or general-purpose computer including a controller 101, a storage 102, a communicator 103, an operator 104, and a display 105.

The controller 101 includes a central processing unit (CPU), a read only memory (ROM), a random access memory (RAM), and the like. The ROM provided in the controller 101 stores control programs and the like for controlling the operation of each component of the hardware provided in the information processing apparatus 100. The CPU in the controller 101 reads and executes control programs stored in the ROM and computer programs stored in the storage 102 to be described later, and controls the operation of each component of the hardware, and thus causes the entire apparatus to function as the information processing apparatus of the present disclosure. The RAM provided in the controller 101 temporarily stores data used during the execution of an arithmetic operation.

In the embodiment, although the controller 101 includes the CPU, the ROM, and the RAM, the configuration of the controller 101 is not limited to the above-described configuration. The controller 101 may be, for example, one or a plurality of control circuits or arithmetic circuits that include a graphics processing unit (GPU), a field programmable gate array (FPGA), a digital signal processor (DSP), a quantum processor, a volatile or nonvolatile memory, or the like. In addition, the controller 101 may include functions such as a clock for outputting date and time information, a timer for measuring the time elapsed from the time when a measurement start instruction is applied to the time when a measurement end instruction is applied, and a counter for counting the number.

The storage 102 includes storage devices such as a hard disk drive (HDD), a solid state drive (SSD), and an electronically erasable programmable read only memory (EEPROM). The storage 102 stores various types of computer programs executed by the controller 101 and various data used by the controller 101.

The computer programs (program products) stored in the storage 102 include a model generation program PG1 for causing the computer to execute processing of generating a model including the first feature value extraction model MD1, an analysis processing program PG2 for causing the computer to execute analysis processing, and the like. These computer programs may be single computer programs or may be program groups including a plurality of computer programs. Further, the computer programs may be executed by a plurality of computers in cooperation with each other. Further, the computer programs may partially use an existing library.

The computer programs such as the model generation program PG1 and the analysis processing program PG2 are provided by a non-temporary (non-transitory) recording medium RM on which the computer programs are recorded in a readable manner. The recording medium RM is a portable memory such as a CD-ROM, a USB memory, a secure digital (SD) card, or a micro SD card. The controller 101 reads various types of computer programs from the recording medium RM using a reading device (not illustrated) and stores the read various types of computer programs in the storage 102. In addition, the computer program stored in the storage 102 may be provided through communication. In this case, the controller 101 downloads the computer program through communication via the communicator 103, and stores the downloaded computer program in the storage 102.

Further, the storage 102 stores models such as the first feature value extraction model MD1, the second feature value extraction model MD2, and the abnormality detection model MD10. These models may be stored in an external apparatus. In this case, the controller 101 of the information processing apparatus 100 may access the external apparatus via a communication network, transmit data acquired from the substrate processing apparatus 200 to the external apparatus, and acquire, via the communication network, an analysis result obtained by the external apparatus.

The communicator 103 includes a communication interface for transmitting and receiving various types of data to and from an external apparatus. As the communication interface of the communicator 103, a communication interface conforming to a communication standard such as a local area network (LAN) can be used. An example of the external apparatus is the substrate processing apparatus 200 described above. Alternatively, the external apparatus may be a user terminal or an external server. When data to be transmitted is input from the controller 101, the communicator 103 transmits the data to the external apparatus that is a destination, and outputs the received data to the controller 101 when the data transmitted from the external apparatus is received.

The operator 104 includes operating devices such as a touch panel, a keyboard, and switches, and receives various types of operations and settings by the user or the like. The controller 101 performs appropriate controls based on various operation information supplied by the operator 104, and causes the storage 102 to store setting information as necessary.

The display 105 includes a display device such as a liquid crystal monitor or an organic electro-luminescence (EL) monitor, and displays information to be notified to the user or the like in response to an instruction from the controller 101.

In embodiments, the information processing apparatus 100 may be a single computer or may be a computer system including a plurality of computers, peripheral devices, and the like. In addition, the information processing apparatus 100 may be a virtual machine in which entities are virtualized, or may be a cloud. Further, although the information processing apparatus 100 and the substrate processing apparatus 200 are described as being separate from each other in the embodiment, the information processing apparatus 100 may be provided inside the substrate processing apparatus 200.

Hereinafter, the operation of the information processing apparatus 100 will be described.

The information processing apparatus 100 according to the embodiment learns an interrelationship between the first modality and the second modality in a learning phase before an actual operation in the substrate processing apparatus 200 is started.

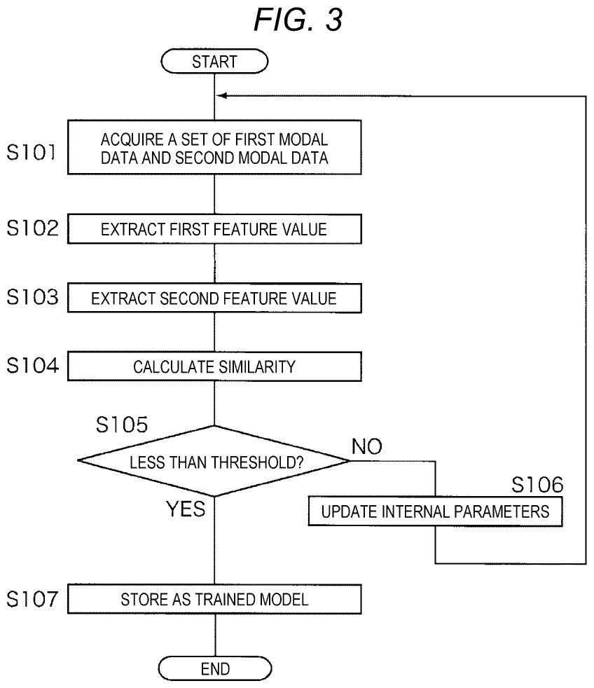

FIG. 3 is a flowchart illustrating a procedure of learning the interrelationship between the first modality and the second modality. Before learning the interrelationship, the first feature value extraction model MD1 and the second feature value extraction model MD2 are set with their respective internal parameters, and are provided as extractors that extract the first feature value and the second feature value, respectively, when the first modal data and the second modal data are received, respectively. Here, the internal parameters of the first feature value extraction model MD1 and the second feature value extraction model MD2 are parameters such as weights and biases among nodes in the input layer, the intermediate layer, and the output layer of each model.

The controller 101 reads the model generation program PG1 from the storage 102 and executes the model generation program PG1 to perform the following processing.

The controller 101 acquires a set of first modal data and second modal data from the substrate processing apparatus 200 (step S101). In step S101, for example, the first modal data and the second modal data may be observed in a same step of the same recipe and are acquired as a set of data.

The controller 101 inputs the acquired first modal data into the first feature value extraction model MD1, and performs an arithmetic operation using the first feature value extraction model MD1 to extract a first feature value (step S102). Similarly, the controller 101 inputs the obtained second modal data into the second feature value extraction model MD2, and performs an arithmetic operation using the second feature value extraction model MD2 to extract a second feature value (step S103). In the flowchart, the procedure of extracting the second feature value after the first feature value is extracted is illustrated. Alternatively, the extractions in the procedure may be performed in reverse sequence or in parallel at the same time.

The controller 101 calculates a similarity between the feature value extracted in step S102 and the feature value extracted in step S103 (step S104). The similarity is an index of how close or far the feature values extracted from the modal data are. Specifically, the similarity is calculated using a method such as mean squared error (MSE) or cosine similarity. For example, when the first feature value is represented by x and the second feature value is represented by y (x and y are vectors), the mean squared error is calculated by Equation 1, and the cosine similarity is calculated by Equation 2.

$${MSE = ‖ x - y 〛}^{2} \qquad [ Equation 1 ]$$

$$Cosine = \frac{x \cdot y}{( ‖ x ‖ ‖ y ‖ )} \qquad [ Equation 2 ]$$

The controller 101 determines whether the calculated similarity is smaller than a threshold (step S105). The threshold may be set in advance and stored in the storage 102. The controller 101 compares the similarity calculated in step S104 with the threshold stored in the storage 102, and determines whether the calculated similarity is less than the threshold.

When it is determined that the calculated similarity is equal to or larger than the threshold (NO in step S105), the controller 101 updates the internal parameters (weights and biases between the nodes) of the first feature value extraction model MD1 and the second feature value extraction model MD2 (step S106), and returns the processing to step S101 to continue the learning. The controller 101 can advance the learning by using an error back propagation method that sequentially updates the weights and biases between the nodes from the output layer toward the input layer of each model.

When an error function (similarity) falls below the threshold (S105: YES) in the process of minimizing the error function (similarity) by a gradient effect method such as the steepest descent method, the controller 101 determines that the learning is completed. At this time, since the first feature value extraction model MD1 and the second feature value extraction model MD2, which learns the interrelationship between the first modality and the second modality, are obtained, the controller 101 stores the first feature value extraction model MD1 and the second feature value extraction model MD2 as trained models in the storage 102 (step S107). In order to avoid the problem of over-learning, the controller 101 may adopt a method such as cross-validation or early termination to end the learning at an appropriate timing.

In the flowchart shown in FIG. 3, the procedure of training both the first feature value extraction model MD1 and the second feature value extraction model MD2 is adopted. Alternatively, a procedure of fixing either the first feature value extraction model MD1 or the second feature value extraction model MD2 and training the other may be adopted. For example, the second feature value extraction model MD2 may be trained in advance using a training method, and the first feature value extraction model MD1 may be trained (the internal parameters of the second feature value extraction model MD2 may be fixed) according to the similarity between the second feature value extracted by the second feature value extraction model MD2 and the first feature value extracted by the first feature value extraction model MD1. Similarly, the first feature value extraction model MD1 may be trained in advance, and the second feature value extraction model MD2 may be trained (the first feature value extraction model MD1 may be fixed) according to the similarity between the feature values.

The information processing apparatus 100 according to Embodiment 1 performs abnormality detection in an operation phase after the training of the first feature value extraction model MD1 and the second feature value extraction model MD2 is completed.

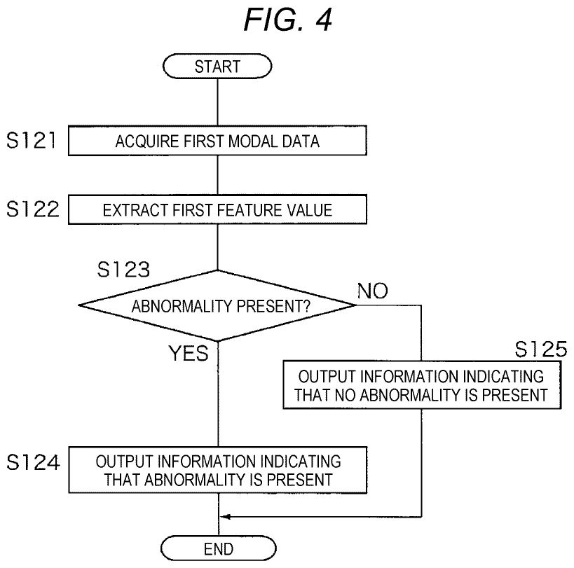

FIG. 4 is a flowchart illustrating a procedure of performing abnormality detection processing. The controller 101 reads the analysis processing program PG2 from the storage 102 and executes the analysis processing program PG2 to perform the following processing.

The controller 101 acquires the first modal data observed in the substrate processing apparatus 200 during the execution of the substrate processing (step S121). The controller 101 inputs the acquired first modal data into the first feature value extraction model MD1, and performs an arithmetic operation using the first feature value extraction model MD1 to extract the first feature value (step S122).

Based on the extracted first feature value, the controller 101 determines the presence or absence of an abnormality in the substrate processing (step S123). For example, the controller 101 determines the presence or absence of an abnormality by determining whether the first feature value falls outside a set value or set range. Alternatively, the first feature value when the first modal data is normal may be stored in the storage 102, the first feature value extracted in step S122 may be compared with the normal first feature value stored in the storage 102, and if a difference therebetween is equal to or larger than a set value or set amount, it may be determined to be abnormal. Without being limited to these methods, the controller 101 may detect an abnormality by using any method.

When it is determined in step S123 that an abnormality is present (S123: YES), the controller 101 outputs information indicating presence of an abnormality in the substrate processing (step S124), and when it is determined in step S123 that no abnormality is present (S123: NO), the controller 101 outputs information indicating absence of an abnormality in the substrate processing (step S125). Specifically, the controller 101 displays, on the display 105, information indicating the presence of an abnormality (or the absence of an abnormality). Alternatively, the communicator 103 may notify a user terminal of information indicating the presence of an abnormality (or the absence of an abnormality).

In the flowchart in FIG. 4, the presence or absence of an abnormality in the substrate processing is determined using only the first modal data. In the embodiment, since the interrelationship between the first modality and the second modality is learned in the learning phase, even if the abnormality detection is performed using only the first modal data, it is possible to perform the abnormality detection in consideration of information on the second modality. For example, in a case where an interrelationship between OES (first modality) and WIS (second modality) is learned, even when only measurement data of OES is used, the abnormality detection in consideration of spatial information obtained by WIS is possible.

### Embodiment 2

In Embodiment 2, a configuration will be described in which interrelationships between a plurality of modalities are learned through a plurality of experiments about substrate processing.

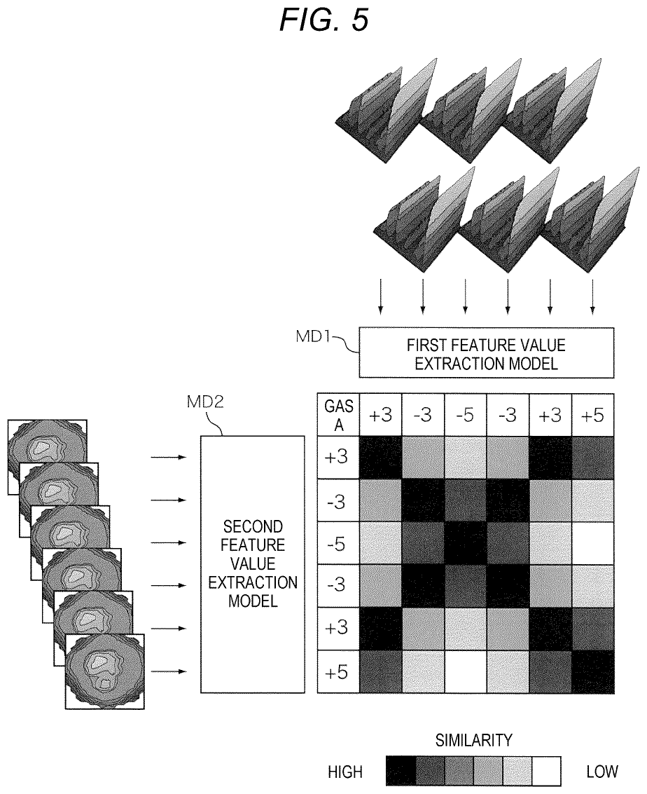

FIG. 5 is an illustrative diagram illustrating a method of setting similarity between a first feature value and a second feature value. The information processing apparatus 100 according to Embodiment 2 uses reference data about the substrate processing to set the similarity between the first feature value and the second feature value. As the reference data, for example, a set value in a recipe defining an experimental procedure can be used.

The example in FIG. 5 illustrates, by shading in black and white, a degree of similarity between the first feature value obtained by the first feature value extraction model MD1 and the second feature value obtained by the second feature value extraction model MD2. In this example, parameters (flow velocity, flow rate, pressure, and the like) relating to a gas A prescribed in the recipe are used as the reference data. In a case where an absolute value of a difference between a parameter relating to the gas A when the first modal data is obtained and a parameter relating to the gas A when the second modal data is obtained is relatively small (or relatively large), the similarity between the first feature value and the second feature value is set to be high (or low).

Although an example in which a recipe is used as the reference data will be described in the embodiment, the reference data is not limited to the recipe, and measured performance data, other modal data, log data, and the like can be used.

The controller 101 of the information processing apparatus 100 trains at least one of the first feature value extraction model MD1 and the second feature value extraction model MD2 based on the degree of similarity between the first feature value and the second feature value. That is, when the difference between the two parameters is small, the controller 101 trains at least one of the first feature value extraction model MD1 and the second feature value extraction model MD2 such that the similarity between the first feature value and the second feature value is high. When the difference between the two parameters is large, the controller 101 trains at least one of the first feature value extraction model MD1 and the second feature value extraction model MD2 such that the similarity between the first feature value and the second feature value is low.

For the sake of illustration, FIG. 5 shows the similarity between the first feature value and the second feature value as being expressed by shading in black and white. In other implementations, the similarity may be expressed within a table or by a function. The controller 101 compares the similarity calculated using the first feature value and the second feature value with similarity set based on the reference data (similarity between the first feature value and the second feature value), and trains at least one of the first feature value extraction model MD1 and the second feature value extraction model MD2 so as to satisfy the similarity.

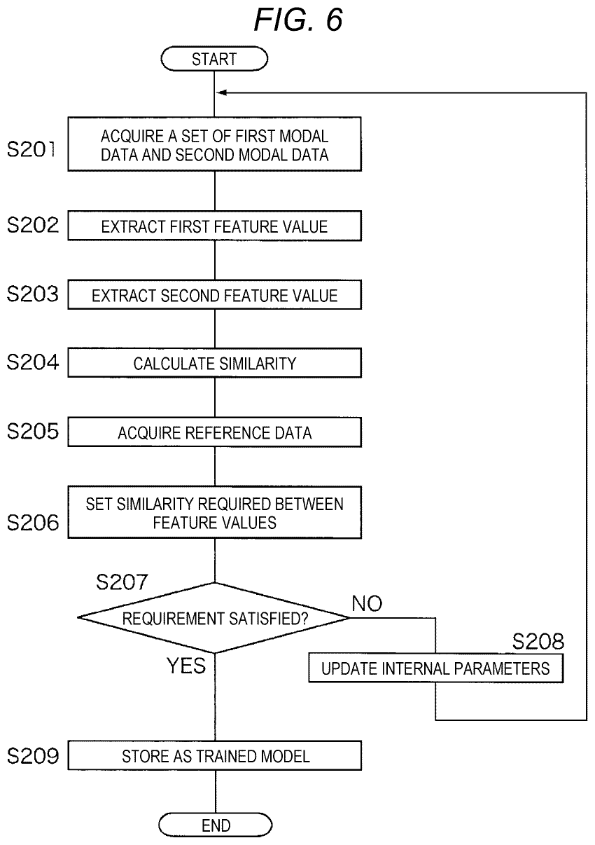

FIG. 6 is a flowchart illustrating a learning procedure in Embodiment 2. The controller 101 acquires a set of first modal data and second modal data through the same procedure as in Embodiment 1 (step S201), and extracts a first feature value and a second feature value from the first modal data and the second modal data, respectively (steps S202 and S203). The controller 101 calculates similarity between the first feature value extracted in step S202 and the second feature value extracted in step S203 (step S204). The similarity is calculated by using a method such as the mean square error or cosine similarity.

Subsequently, the controller 101 acquires reference data from the substrate processing apparatus 200 (step S205). Based on the acquired reference data, the controller 101 sets similarity between the first feature value and the second feature value (step S206). For example, the controller 101 compares reference data obtained when the first modal data is obtained with reference data obtained when the second modal data is obtained, and sets the similarity between the first feature value and the second feature value based on a difference therebetween.

The controller 101 compares the similarity calculated in step S204 with the similarity set in step S206, and determines whether the calculated similarity satisfies a requirement (step S207). When it is determined that the requirement is not satisfied (step S207: NO), the controller 101 updates internal parameters (weights and biases between the nodes) of the first feature value extraction model MD1 and the second feature value extraction model MD2 (step S208), and returns the processing to step S201 to continue the learning. The controller 101 can advance the learning by using an error back propagation method that sequentially updates the weights and biases between the nodes from the output layer toward the input layer of each model.

When it is determined that the requirement is satisfied (S207: YES), the controller 101 determines that the learning is completed. At this time, since the first feature value extraction model MD1 and the second feature value extraction model MD2, which learn the interrelationship between the first modality and the second modality, are obtained, the controller 101 stores the first feature value extraction model MD1 and the second feature value extraction model MD2 as trained models in the storage 102 (step S209). In order to avoid the problem of over-learning, the controller 101 may adopt a method such as cross-validation or early termination to end the learning at an appropriate timing.

As described above, in Embodiment 2, it is possible to extract feature values in consideration of the similarity with the reference data in the substrate processing, and the learning can be advanced using a plurality of experimental results.

### Embodiment 3

In Embodiment 3, a configuration will be described in which a factor analysis is performed when an abnormality is detected by the abnormality detection model MD10.

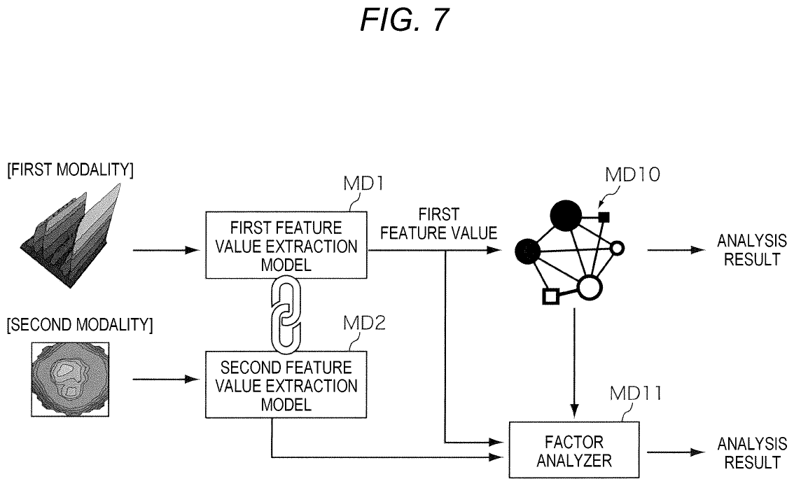

FIG. 7 is an illustrative diagram illustrating an outline of factor analysis processing. The information processing apparatus 100 according to Embodiment 3 includes a factor analyzer MD11, in addition to the first feature value extraction model MD1, the second feature value extraction model MD2, and the abnormality detection model MD10 described above.

When an abnormality in substrate processing is detected using the abnormality detection model MD10, the factor analyzer MD11 specifies a specific abnormal portion based on an abnormal feature value. For example, the factor analyzer MD11 calculates contribution of the first feature value or the second feature value to the abnormality, and specifies an abnormal portion of first modal data or second modal data based on the calculated contribution. Methods such as local interpretable model-agnostic explanations (Lime), Shapley Additive explanations (SHAP), and class activation mapping (CAM) may be used for the calculation of importance. Lime and SHAP specify how much an output changes when an input is reduced, and determine that the more greatly the output has changed, the higher the importance is. CAM is a method for calculating importance using error back propagation during learning.

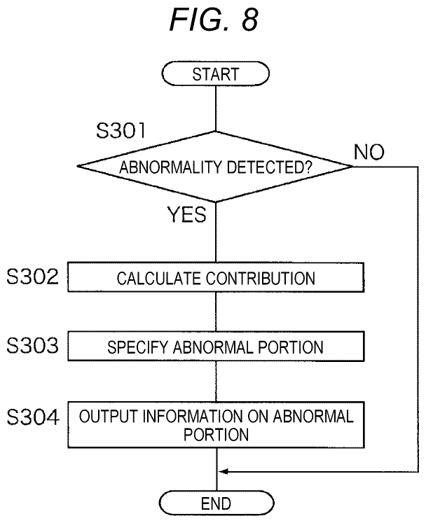

FIG. 8 is a flowchart illustrating a procedure of processing executed by the information processing apparatus 100 according to Embodiment 3. The controller 101 executes abnormality detection processing in the same procedure as in Embodiment 1, and determines whether an abnormality is detected (step S301). When no abnormality is detected (S301: NO), the controller 101 ends the processing according to the flowchart without executing the following processing.

When it is determined that an abnormality is detected (step S301: YES), the controller 101 calculates a contribution of the first feature value or the second feature value to the abnormality (step S302). The controller 101 can calculate the contribution of the first feature value or the second feature value to the abnormality by using a method such as Lime, SHAP, or CAM.

Based on the calculated contribution, the controller 101 specifies a portion of the first modal data or the second modal data with a high contribution to the abnormality (step S303).

The controller 101 outputs information on the specified abnormal portion (step S304). Specifically, the controller 101 displays, on the display 105, the information on the specified abnormal portion. Alternatively, the communicator 103 may notify a user terminal of the information on the specified abnormal portion.

As described above, in Embodiment 3, when an abnormality is detected by the abnormality detection model MD10, a factor analysis thereof can be performed.

### Embodiment 4

In Embodiment 4, data expansion processing will be described.

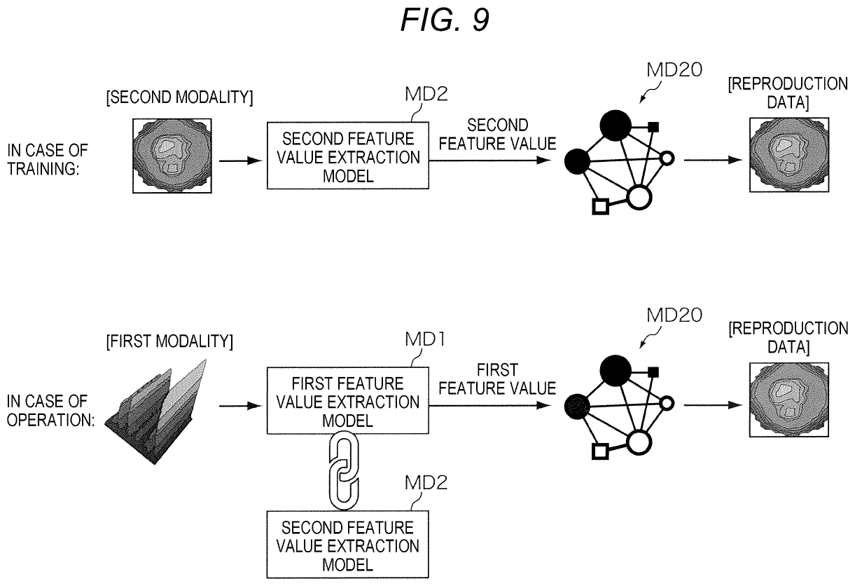

FIG. 9 is an illustrative diagram illustrating an outline of data expansion processing. The information processing apparatus 100 according to Embodiment 4 includes a data generation model MD20, in addition to the first feature value extraction model MD1 and the second feature value extraction model MD2 described above.

The data generation model MD20 in Embodiment 4 is trained to generate reproduction data of second modal data in response to an input of a second feature value. As the data generation model MD20, a model such as a variable auto-encoder (VAE) can be used. The VAE is an auto-encoder configured to compress input data into a feature value and restore the feature value to its original data. The VAE is a model that enables the probabilistic generation of unknown data by introducing a probability distribution to the feature value. In the embodiment, the processing of compressing the input data into a feature value is executed by the second feature value extraction model MD2.

The data generation model MD20 is generated by repeating processing of comparing input data to the second feature value extraction model MD2 with output data from the data generation model MD20, and updating internal parameters of the model based on a comparison result.

The data generation model MD20 is not limited to the VAE, and may be a model using a generative adversarial network (GAN), a SegNet, a fully convolutional network (FCN), a U-shaped network (U-Net), a pyramid scene parsing network (PSPNet), or the like.

In Embodiment 4, the first feature value extraction model MD1 and the second feature value extraction model MD2 are trained such that a common feature value is included. Specifically, by learning an interrelationship between a first modality and a second modality using the same method as in Embodiment 1, the first feature value extraction model MD1 and the second feature value extraction model MD2 are trained such that a first feature value extracted by the first feature value extraction model MD1 and a second feature value extracted by the second feature value extraction model MD2 include a common feature value.

In Embodiment 4, since the first feature value and the second feature value include the common feature value, reproduction data of the second modal data can be generated even when the first feature value is input into the data generation model MD20. That is, when first modal data is measurement data about plasma emission intensity obtained by OES and the second modal data is image data obtained by WIS, the image data obtained by WIS can be generated from the measurement data about plasma emission intensity.

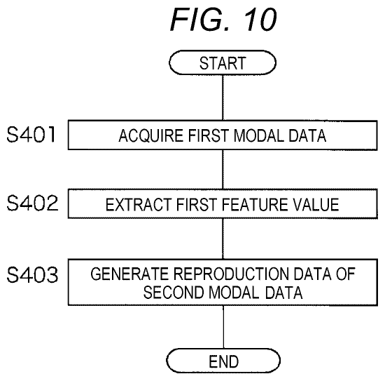

FIG. 10 is a flowchart illustrating a procedure of processing executed by the information processing apparatus 100 according to Embodiment 4. The storage 102 of the information processing apparatus 100 stores the first feature value extraction model MD1 and the second feature value extraction model MD2 obtained by learning an interrelationship between a first modality and a second modality. The storage 102 stores the data generation model MD20 that is trained to output reproduction data of second modal data when a first feature value or a second feature value is received.

The controller 101 acquires first modal data from the substrate processing apparatus 200 (step S401). The controller 101 inputs the acquired first modal data into the first feature value extraction model MD1, and performs an arithmetic operation using the first feature value extraction model MD1 to extract a first feature value (step S402).

The controller 101 inputs the first feature value extracted using the first feature value extraction model MD1 into the data generation model MD20, and executes an arithmetic operation using the data generation model MD20 to generate reproduction data of second modal data (step S403).

As described above, in Embodiment 4, the reproduction data of the second modal data is generated from the first modal data. In Embodiment 4, data that is relatively difficult to acquire (for example, data indicative of performance such as an SEM image) is generated from data of a modal that is easily acquired (for example, data about plasma emission intensity obtained by OES). In addition, since data that is relatively difficult to acquire can be generated, generalization and accuracy improvement of any machine learning model can be expected by using these data as training data.

### Embodiment 5

In Embodiment 5, prediction processing of performance will be described.

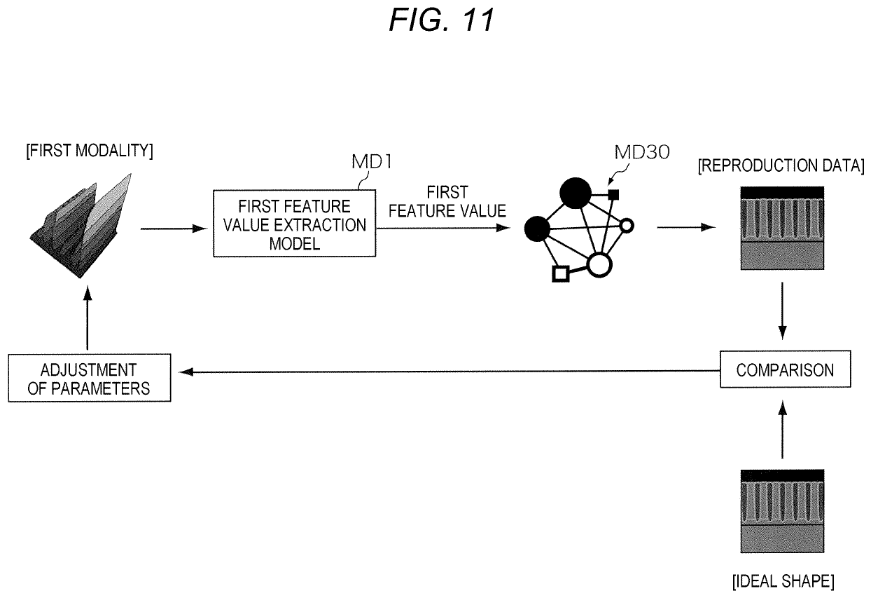

FIG. 11 is an illustrative diagram illustrating an outline of prediction processing. The information processing apparatus 100 according to Embodiment 5 includes a prediction model MD30, in addition to the first feature value extraction model MD1 and the second feature value extraction model MD2 described above.

Similarly to Embodiment 4, the first feature value extraction model MD1 and the second feature value extraction model MD2 are trained such that a first feature value and a second feature value include a common feature value. First modal data in Embodiment 5 is, for example, measurement data about plasma emission intensity obtained by OES, and second modal data is, for example, SEM image data representing performance of substrate processing.

The prediction model MD30 is trained to output reproduction data of an SEM image when the second modal data (SEM image data) is received. Similarly to Embodiment 4, the prediction model MD30 is a model using VAE, GAN, SegNet, FCN, U-Net, PSPNet, or the like. The prediction model MD30 is generated by repeating processing of comparing input data to the second feature value extraction model MD2 with output data from the prediction model MD30, and updating internal parameters of the model based on a comparison result.

In Embodiment 5, since the first feature value and the second feature value include the common feature value, when the first feature value is input into the prediction model MD30, reproduction data of second modal data can be generated. In Embodiment 5, even when modal data that is relatively difficult to acquire, such as an SEM image, is not obtained, the performance can be predicted by using modal data that is easy to acquire, such as the plasma emission intensity.

Further, in Embodiment 5, since the performance can be predicted, the predicted performance (reproduction data) may be compared with desired performance (data about an ideal shape), and parameters in substrate processing may be adjusted according to a comparison result. Here, the parameters in the substrate processing are apparatus parameters such as a temperature, a gas pressure, and a gas flow rate in a chamber, voltage values of radio-frequency voltages to be applied to an upper electrode and a lower electrode, or set values of recipes.

A rule-based adjustment method is used to adjust the parameters. For example, a pattern shape estimated from the predicted reproduction data is compared with an ideal shape, and when a difference between the predicted pattern shape and the ideal shape is X %, the parameters are adjusted according to a rule such as changing a set value such as a voltage value of the radio-frequency voltage by Y % (Y is a function of X). The adjustment method of the parameter is not limited to the rule base, and any method such as a machine learning model or a statistical model may be used.

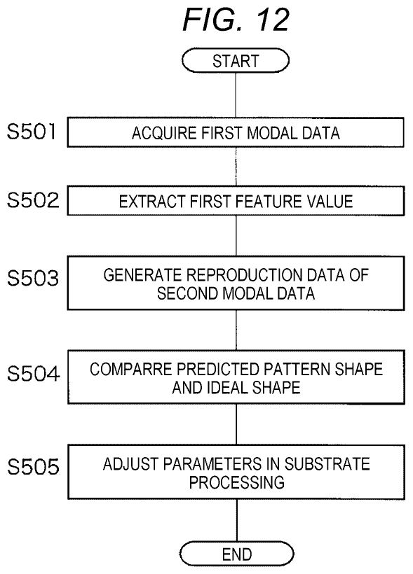

FIG. 12 is a flowchart illustrating a procedure of processing executed by the information processing apparatus 100 according to Embodiment 5. The storage 102 of the information processing apparatus 100 stores the first feature value extraction model MD1 and the second feature value extraction model MD2 obtained by learning an interrelationship between a first modality and a second modality. Further, the storage 102 stores the prediction model MD30 that is trained to output information on the performance (reproduction data of second modal data) in the substrate processing when the first feature value or the second feature value is received.

The controller 101 acquires first modal data from the substrate processing apparatus 200 (step S501). The first modal data is, for example, measurement data about plasma emission intensity obtained by OES. The controller 101 inputs the acquired first modal data into the first feature value extraction model MD1, and performs an arithmetic operation using the first feature value extraction model MD1 to extract a first feature value (step S502).

The controller 101 inputs the first feature value extracted using the first feature value extraction model MD1 into the prediction model MD30, and performs an arithmetic operation using the prediction model MD30 to generate reproduction data of second modal data (step S503). The reproduction data of the second modal data is, for example, SEM image data, and represents performance in the substrate processing.

The controller 101 compares a pattern shape estimated from the predicted reproduction data with an ideal shape (step S504), and adjusts parameters in the substrate processing based on a comparison result (step S505).

As described above, in Embodiment 5, the performance can be predicted using modal data, which is relatively easy to acquire by OES or the like, without using an SEM image that is relatively difficult to acquire. Further, in Embodiment 5, the parameters in the substrate processing can be adjusted such that the performance approaches desired performance.

### Embodiment 6

In Embodiment 6, noise removal processing will be described.

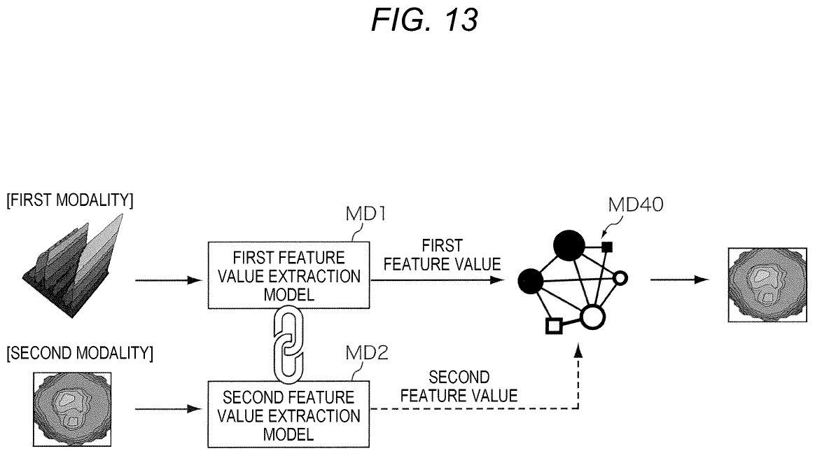

FIG. 13 is an illustrative diagram illustrating an outline of noise removal processing. The information processing apparatus 100 according to Embodiment 6 includes a noise removal model MD40, in addition to the first feature value extraction model MD1 and the second feature value extraction model MD2 described above.

Similarly to Embodiment 4, the first feature value extraction model MD1 and the second feature value extraction model MD2 are trained such that a first feature value and a second feature value include a common feature value. First modal data in Embodiment 6 is, for example, measurement data about plasma emission intensity obtained by OES, and second modal data is, for example, image data obtained by WIS.

The noise removal model MD40 is trained to output reproduction data of second modal data without noise when the second modal data is received. The noise includes a missing value, an outlier value, and additive white Gaussian noise (AWGN) in the data. Similarly to Embodiment 4, the noise removal model MD40 is a model using VAE, GAN, SegNet, FCN, U-Net, PSPNet, or the like. The noise removal model MD40 is generated by repeating processing of comparing input data without noise (second modal data without missing or the like) with output data from the noise removal model MD40, and updating internal parameters of the model based on a comparison result.

In Embodiment 6, since the first feature value and the second feature value include a common feature value, when the first feature value (or a combination of the first feature value and the second feature value) is input into the noise removal model MD40, the reproduction data of the second modal data without noise can be generated.

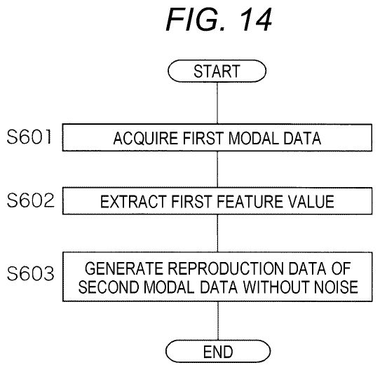

FIG. 14 is a flowchart illustrating a procedure of processing executed by the information processing apparatus 100 according to Embodiment 6. The storage 102 of the information processing apparatus 100 stores the first feature value extraction model MD1 and the second feature value extraction model MD2 obtained by learning an interrelationship between a first modality and a second modality. Further, the storage 102 stores the noise removal model MD40 that is trained to output the reproduction data of the second modal data without noise when at least one of the first feature value or the second feature value is received.

The controller 101 acquires first modal data from the substrate processing apparatus 200 (step S601). The first modal data is, for example, measurement data about plasma emission intensity obtained by OES. The controller 101 inputs the acquired first modal data into the first feature value extraction model MD1, and performs an arithmetic operation using the first feature value extraction model MD1 to extract a first feature value (step S602).

The controller 101 inputs the first feature value extracted using the first feature value extraction model MD1 into the noise removal model MD40, and performs an arithmetic operation using the noise removal model MD40 to generate reproduction data of the second modal data without noise (step S603). The reproduction data of the second modal data is, for example, image data obtained by WIS.

As described above, in Embodiment 6, even when noise is included in the input (first modal data), the second modal data without noise can be reproduced.

The embodiments disclosed herein are exemplary in all respects and are to be considered to be not restrictive embodiments. The scope of the present disclosure is indicated by the scope of the aspects, not the meaning described above, and is intended to include meanings equivalent to the scope of the aspects and all changes within the scope.

For example, in Embodiments 1 to 6, the feature value extraction model that learns an interrelationship between two types of modalities is generated. Alternatively, a feature value extraction model that learns interrelationships between three or more types of modalities may be generated.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the present disclosure is not limited thereto. The claims may also be described using a format of multi-claims reciting at least one multi-claim (multi-multi claims).

1. A non-transitory computer-readable medium storing a computer program which, when executed by a computer, causes the computer to execute processing comprising:
acquiring a first feature value from a first feature value extraction model which outputs the first feature value when data of a first modality about substrate processing is received;
acquiring a second feature value from a second feature value extraction model, which outputs the second feature value when data of a second modality different from the first modality is received;
calculating a similarly between the first feature value and second feature value; and
training at least one of the first feature value extraction model and the second feature value extraction model based on the similarity.

2. The non-transitory computer-readable medium according to claim 1, wherein the processing further includes fixing one of the first feature value extraction model and the second feature value extraction model and training the other such that the similarity is above a threshold value.

3. The non-transitory computer-readable medium according to claim 1, wherein the processing further includes:
acquiring reference data about the substrate processing; and
setting the similarity between the first feature value and the second feature value based on the acquired reference data.

4. The non-transitory computer-readable medium according to claim 1, wherein the processing further includes detecting an abnormality in the substrate processing according to an abnormality detection model, which outputs information on a presence or an absence of the abnormality in the substrate processing in response to an input of the first feature value or the second feature value.

5. The non-transitory computer-readable medium according to claim 4, wherein the processing further includes:
calculating a contribution of the first feature value or the second feature value to the abnormality; and
specifying an abnormal portion in data of the first modality or data of the second modality based on the calculated contribution.

6. The non-transitory computer-readable medium according to claim 1, wherein the processing further includes:
training the first feature value extraction model and the second feature value extraction model such that the first feature value and the second feature value include a common feature value; and
inputting the second feature value into a data generation model, which outputs reproduction data of the first modality in response to an input of the first feature value, to generate reproduction data of the first modality.

7. The non-transitory computer-readable medium according to claim 1, wherein the processing further includes predicting a performance in the substrate processing according to a prediction model, which outputs information on the performance in response to an input of the first feature value or the second feature value.

8. The non-transitory computer-readable medium according to claim 7, wherein the processing further includes:
comparing the performance predicted using the prediction model with a particular performance; and
adjusting a parameter in the substrate processing based on a result of the comparing.

9. The non-transitory computer-readable medium according to claim 1, wherein the processing further includes generating data of a second modality, from which noise is removed, using a noise removal model which outputs the data of the second modality in response to an input of the first feature value or the second feature value.

10. An information processing apparatus, comprising:
a memory which stores a first feature value extraction model and a second feature value extraction model, wherein the first feature value extraction model outputs a first feature value when data of a first modality about substrate processing is received, and the second feature value extraction model outputs a second feature value when data of a second modality different from the first modality is received; and
circuitry configured to
calculate a similarly between the first feature value and the second feature value; and
train at least one of the first feature value extraction model and the second feature value extraction model based on the similarity.

11. The information processing apparatus according to claim 10, wherein the circuitry is further configured to:
fix one of the first feature value extraction model and the second feature value extraction model; and
train the other such that the similarity is above a threshold value.

12. The information processing apparatus according to claim 10, wherein
the memory is further configured to store reference data about the substrate processing, and
the circuitry is further configured to set the similarity between the first feature value and the second feature value based on the acquired reference data.

13. The information processing apparatus according to claim 10, wherein the circuitry is further configured to:
detect an abnormality in the substrate processing according to an abnormality detection model, which outputs information on a presence or an absence of the abnormality in the substrate processing in response to an input of the first feature value or the second feature value.

14. The information processing apparatus according to claim 13, wherein the circuitry is further configured to:
calculate a contribution of the first feature value or the second feature value to the abnormality; and
specify an abnormal portion in data of the first modality or data of the second modality based on the calculated contribution.

15. The information processing apparatus according to claim 10, wherein the circuitry is further configured to:
train the first feature value extraction model and the second feature value extraction model such that the first feature value and the second feature value include a common feature value; and
input the second feature value into a data generation model, which outputs reproduction data of the first modality in response to an input of the first feature value, to generate reproduction data of the first modality.

16. The information processing apparatus according to claim 10, wherein the circuitry is further configured to:
predict a performance in the substrate processing according to a prediction model, which outputs information on the performance in response to an input of the first feature value or the second feature value.

17. The information processing apparatus according to claim 16, wherein the circuitry is further configured to:
compare the performance predicted using the prediction model with a particular performance; and
adjust a parameter in the substrate processing based on a result of the comparing.

18. The information processing apparatus according to claim 10, wherein the circuitry is further configured to:
generate data of a second modality, from which noise is removed, using a noise removal model which outputs the data of the second modality in response to an input of the first feature value or the second feature value.

19. An information processing method, comprising:
acquiring a first feature value from a first feature value extraction model, which outputs the first feature value when data of a first modality about substrate processing is received;
acquiring a second feature value from a second feature value extraction model, which outputs the second feature value when data of a second modality different from the first modality is received;
calculating, by circuitry, a similarly between the first feature value and second feature value; and
training, by the circuitry at least one of the first feature value extraction model and the second feature value extraction model based on the similarity.

20. The information processing method according to claim 19, further comprising:
acquiring reference data about the substrate processing; and
setting the similarity between the first feature value and the second feature value based on the acquired reference data.
